(19) United States
(12) Patent Application Publication
(10) Pub. No.: US 2026/0281994 A1
(43) Pub. Date: Sep. 17, 2026

(54) METHOD, DEVICE, AND MEDIUM FOR UNSUPPORTED RFSP INDEX RECOVERY SERVICE

(71) Applicant: Verizon Patent and Licensing Inc., Basking Ridge, NJ (US)

(72) Inventors: Violeta Cakulev, Millburn, NJ (US); Lixia Yan, Basking Ridge, NJ (US); Ali Imdad Malik, East Brunswick, NJ (US); Ratul K. Guha, Warwick, PA (US); Hossein M. Ahmadi, Parsippany, NJ (US)

(21) Appl. No.: 19/076,209

(22) Filed: Mar. 11, 2025

(51) Int. Cl. H04W 72/0453; H04W 24/04

(52) U.S. Cl. CPC H04W 72/0453; H04W 24/04

(57) ABSTRACT

A method, a network device, and a non-transitory computer-readable storage medium are described in relation to a unsupported RFSP index recovery service. The unsupported RFSP index recovery service may enable recovery of a network procedure that fails due to an unsupported RFSP index. The unsupported RFSP index recovery service may include an RFSP index failure trigger. The unsupported RFSP index recovery service may include obtaining a supported RFSP index from a radio access network device to which the failed network procedure pertains. The unsupported RFSP index recovery service may include obtaining an updated RFSP index and reperforming the failed network procedure with the updated RFSP index.

### BACKGROUND

Development and design of networks present certain challenges from a network-side perspective and an end device perspective. For example, the establishment and maintenance of end device connectivity in a radio network environment present technical challenges. Among other parameters that support radio resource management (RRM), a Radio Access Technology (RAT) Frequency Selection Priority (RFSP) index mechanism may be used to assist end devices in RAT and frequency selection and optimize network performance, for example.

### BRIEF DESCRIPTION OF THE DRAWINGS

FIG. 1 is a diagram illustrating an exemplary environment in which an exemplary embodiment of a unsupported RFSP index recovery service may be implemented;

FIG. 2A is a diagram illustrating an exemplary process of an exemplary embodiment of the unsupported RFSP index recovery service;

FIG. 2B is a diagram illustrating another exemplary process of an exemplary embodiment of the unsupported RFSP index recovery service;

FIG. 2C is a diagram illustrating yet another exemplary process of an exemplary embodiment of the unsupported RFSP index recovery service;

FIG. 2D is a diagram illustrating still another exemplary process of an exemplary embodiment of the unsupported RFSP index recovery service;

FIG. 3 is a diagram illustrating exemplary components of a device that may correspond to one or more of the devices illustrated and described herein;

FIG. 4 is a flow diagram illustrating an exemplary process of an exemplary embodiment of the unsupported RFSP index recovery service;

FIG. 5 is a flow diagram illustrating another exemplary process of an exemplary embodiment of the unsupported RFSP index recovery service; and

FIG. 6 is a flow diagram illustrating another exemplary process of an exemplary embodiment of the unsupported RFSP index recovery service.

### DETAILED DESCRIPTION

The following detailed description refers to the accompanying drawings. The same reference numbers in different drawings may identify the same or similar elements. Also, the following detailed description does not limit the invention.

To support radio resource management strategies in a wireless environment, such as a Fifth Generation (5G) radio access network (RAN), an access and mobility management function (AMF) may provide an RFSP index to the 5G RAN. The 5G RAN may map the RFSP index to locally defined configuration so as to apply specific radio resource management strategies, taking into account any available information in the 5G RAN. The RFSP index is UE specific and applies to all the radio bearers. The 5G RAN may use the RFSP index to derive user equipment (UE) specific cell reselection priorities to control idle mode camping, to decide on redirecting active mode UEs to different frequency layers or RATs, among other types of RRM-related procedures.

The home public land mobile network (HPLMN) may set the RFSP index in view of the subscribed single network slice selection assistance information (S-NSSAIs). The AMF may receive the subscribed RFSP index from a unified data management (UDM) device during a registration procedure pertaining to a UE. The AMF may choose the RFSP index in use according to one of the following procedures, depending on an operator's configuration. For example, the AMF may select the RFSP index in use, which may be identical to the subscribed RFSP index. According to another example, the AMF may select the RFSP index in use based on the subscribed RFSP index, locally configured operator policies, the allowed and partially allowed NSSAI, an S-NSSAI rejected partially in the registration area (RA), pending NSSAI and UE-related context information available at the AMF (e.g., including UE's usage setting), among other parameters.

The AMF may report the subscribed RFSP index to a policy control function (PCF) for further evaluation. The AMF may receive and apply an authorized RFSP index, which may or may not differ from the subscribed RFSP index, from the PCF.

The AMF may store the subscribed RFSP index value and the RFSP index value in use. The AMF may provide the authorized RFSP index value to a 5G RAN node using various network procedures, such as an initial context setup, a UE context modification procedure, a downlink (DL) non-access stratum (NAS) transport procedure, or a handover procedure, for example.

Unfortunately, the AMF is not aware of RFSP index values supported by the 5G RAN node. When the 5G RAN node does not support the RFSP index value, the procedure fails and currently there is no mechanism for the 5G RAN node to indicate to the AMF that the procedure failed due to the unsupported RFSP index value. Consequently, the service associated with the RFSP index value is not provided to the UE and negatively impacts the network.

According to exemplary embodiments, an unsupported RFSP index recovery service is described. According to various exemplary embodiments, the unsupported RFSP index recovery service may be implemented in Fourth Generation (4G) and 4G Advanced wireless environments, 5G wireless environments, future generation wireless environments (e.g., 5G Advanced, Sixth Generation (6G), Seventh Generation (7G), etc.), or a multi-RAT wireless environment. According to various exemplary embodiments, the unsupported RFSP index recovery service may be implemented in various contexts, such as non-roaming, roaming, local breakout (LBO), handover, and the like.

According to an exemplary embodiment, the unsupported RFSP index recovery service may include providing an RFSP failure event trigger. According to an exemplary embodiment, a core device may provide RFSP failure event trigger data to another core device as a part of a policy association procedure, as described herein.

According to an exemplary embodiment, the unsupported RFSP index recovery service may include providing notification that an RFSP index value is not supported. According to an exemplary embodiment, the notification may further include one or multiple RFSP index values that are supported. According to an exemplary embodiment, a RAN device may provide the notification to a core network device.

According to an exemplary embodiment, the unsupported RFSP index recovery service may include performing an update procedure in response to the notification. According to an exemplary embodiment, the unsupported RFSP index recovery service may include selecting one or multiple new RFSP index values, as described herein. According to an exemplary embodiment, the unsupported RFSP index recovery service may include reattempting the failed procedure using the one or multiple new RFSP index values, as described herein.

In view of the foregoing, the unsupported RFSP index recovery service may enable recovery from various network procedures that include the core network communicating an RFSP index to the RAN. In this way, radio resource management strategies and mechanisms that are supported by RFSP indexes may be applied to bolster various network performance factors, such as network capacity, network load, network coverage, signal quality, user mobility, user experience, among other metrics.

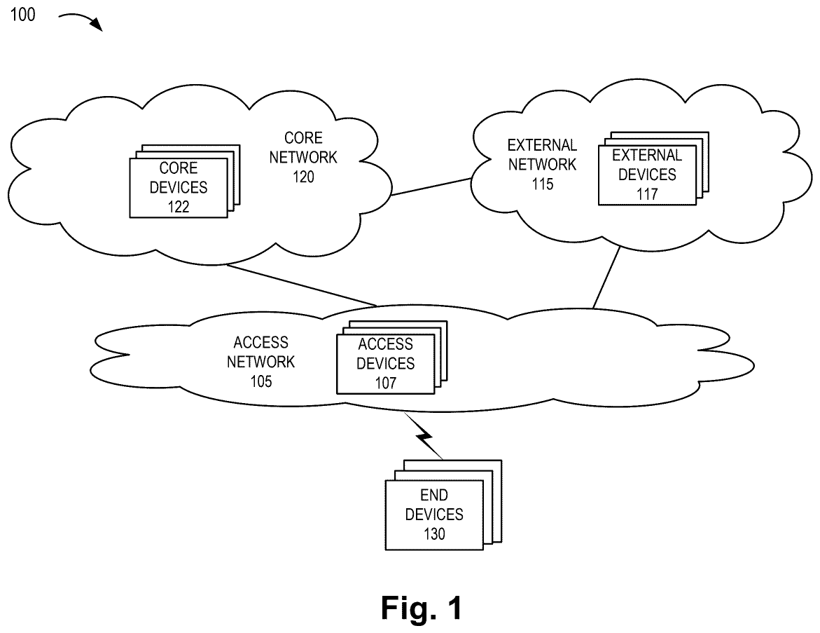

FIG. 1 is a diagram illustrating an exemplary environment 100 in which an exemplary embodiment of unsupported RFSP index recovery service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7(SS7), an optical network, a wired network, etc.), a time-sensitive network (TSN) system, a deterministic networking (DetNet) network, or another type of network that may support a wireless service and/or an application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, quality of service (QoS) flows, packet data unit (PDU) sessions, channels, network paths, tunnels, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, a network management plane, an artificial intelligence and/or a machine learning (AI/ML) (control) plane, and a future generation plane, or a subset thereof. Environment 100 may include other types of planes of communication. A message communicated in support of the unsupported RFSP index recovery service may use at least one of these planes. For example, the message of an exemplary embodiment of unsupported RFSP index recovery service may use the control plane. According to various exemplary implementations, the interface of the network device may be a service-based interface (SBI), a reference point-based interface, an Open Radio Access Network (O-RAN) interface, a 5G interface, another generation of interface (e.g., 5G Advanced, 6G, 7G, 4G, etc.), or some other type of network interface (e.g., proprietary, etc.).

Access network 105 may include one or multiple networks of one or multiple types and technologies. For example, access network 105 may be implemented to include a terrestrial network, a non-terrestrial network (e.g., a satellite network, an air-based network, etc.), or a combination thereof. By way of further example, access network 105 may include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced (LTE-A), LTE Advanced Pro (LTE-A Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA, NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple radio access technologies (RATs) (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to an exemplary embodiment, at least some of access devices 107 include logic of an exemplary embodiment of the unsupported RFSP index recovery service, as described herein. According to various exemplary embodiments, access device 107 may be implemented as an integrated or a split RAN device, such as eNB, an eLTE eNB, a gNB, an RU+DU, a future generation access device 107 (e.g., a 5G advanced wireless station, a 6G wireless station, a 7G wireless station, etc.), or a similar type of cellular-based access device 107, as described herein.

According to an exemplary embodiment, the logic of an exemplary embodiment of the unsupported RFSP index recovery service may include determining whether an RFSP index is supported or not. For example, access device 107 may make this determination in response to receiving a message, which indicates an RFSP index, from core network 120. According to various exemplary embodiments, the message may relate to distinct types of network procedures, such as an initial context setup procedure, a context modification procedure, a handover procedure, a downlink NAS transport procedure, or the like.

According to an exemplary embodiment, access device 107 may generate and transmit a message, which responds to the received message, to the core network. According to an exemplary embodiment, when access device 107 determines that the RFSP index is not supported, the message may include data indicating that the received RFSP index is not supported by access device 107. According to an exemplary embodiment, access device 107 may include one or multiple RFSP index values, which differ from the received RFSP index value, that is or are supported by access device 107.

According to an exemplary embodiment, access device 107 may re-perform the previously failed procedure based on receiving an updated RFSP index value. For example, access device 107 may receive another message, which indicates another RFSP index value, from core network 120, that relates to the same (previously failed) procedure. Access device 107 may determine whether the updated RFSP index value is supported or not. If supported, access device 107 may complete the procedure, as described herein.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IP Multimedia System (IMS) network, a Rich Communication Service (RCS) network, a software defined (SD) network, a virtual network, a packet-switched network, a data center, or other type of network that may provide access to and may host an end device application service or a network application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions, as described herein. External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, massive IoT (mIoT), critical IoT (cIoT), etc.), extreme real-time communications (e.g., tactile Internet, augmented reality (AR), virtual reality (VR), eXtended reality (XR), mixed reality (MR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, gaming (e.g., cloud gaming (CG), etc.), and/or other types of wireless and/or wired application services.

External devices 117 may also include other types of network devices that support the operation of external network 115 and/or the provisioning of application services, such as an orchestrator, an edge manager, an operations support system (OSS), a local domain name system (DNS), registries, a gateway, and/or external devices 117 that may pertain to various network-related functions or services (e.g., security, management, charging, billing, authentication, authorization, policy enforcement, development, communication with other networks, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an AMF, an SMF, a UDM device, a unified data repository (UDR), an authentication server function (AUSF), a network slice selection function (NSSF), a network repository function (NRF), a policy control function (PCF), an NWDAF, a network exposure function (NEF), a service communication proxy (SCP), a Time Sensitive Communication and Time Sensitive Function (TSCTCF), a future generation core device (e.g., a 5G-Advanced core device, a 6G core device, a 7G core device, etc.), a service capability exposure function (SCEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and a charging system (CS), or a sub-combination thereof. Additionally, core devices 122 may include transport devices (e.g., routers or the like), and a transport control device, such as a path computation engine (PCE).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other types of combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 include logic of an exemplary embodiment of the unsupported RFSP index recovery service, as described herein. According to various exemplary embodiments, such core device 122 may be implemented as an AMF, an MME, an interworking core device 122 (e.g., MME+AMF), or a future generation core device 122 that substantially performs functions of the AMF (referred to collectively for purposes of brevity simply as an AMF).

According to various exemplary embodiments, the logic of the unsupported RFSP index recovery service associated with the AMF may relate to different types of network procedures, such as an initial context setup procedure, a context modification procedure, a handover procedure, a downlink NAS transport procedure, a policy association procedure, or another type of procedure that may include communicating an RFSP index value.

According to an exemplary embodiment, the AMF may include receiving a message, which includes an authorized RFSP index value, from another core device 122. According to an exemplary embodiment, the message may further include an event trigger regarding an RFSP failure. For example, the RFSP failure event trigger data may include data indicating to notify the other core device 122 when the RFSP failure occurs in relation to access device 107, as described herein.

According to an exemplary embodiment, the logic of an exemplary embodiment of the unsupported RFSP index recovery service may include determining that an RFSP index is not supported by access device 107. For example, the AMF may make this determination in response to receiving a message, which indicates a failure associated with an RFSP index, from access device 107. According to an exemplary embodiment, the message may include one or multiple RFSP index values, which differ from the failed RFSP index value, that is or are supported by access device 107. According to various exemplary embodiments, the message may relate to diverse types of network procedures, such as an initial context setup procedure, a context modification procedure, a handover procedure, a downlink NAS transport procedure, or the like.

According to an exemplary embodiment, in response to receiving the message, which indicates an unsupported RFSP index, from access device 107, the AMF may include obtaining another authorized RFSP index value from the other core device 122, as described herein. According to an exemplary embodiment, the AMF may transmit a message, which includes data regarding the RFSP failure event, to the other core device 122. According to an exemplary embodiment, the message may further include a supported RFSP index value that was received from access device 107 of relevance, as described herein. According to an exemplary embodiment, the AMF may receive an updated RFSP index value, in response to the message, from the other core device 122.

According to an exemplary embodiment, the AMF may re-perform the previously failed network procedure with access device 107. According to an exemplary embodiment, the AMF may provide the updated RFSP index value to access device 107.

According to an exemplary embodiment, at least some other types of core devices 122 include logic of an exemplary embodiment of the unsupported RFSP index recovery service, as described herein. According to various exemplary embodiments, such core device 122 may be implemented as a PCF, a policy control and charging rules function (PCRF), an interworking core device 122 (e.g., PCRF+PCF), or a future generation core device 122 that substantially performs functions of the PCF (referred to collectively for purposes of brevity simply as a PCF).

According to various exemplary embodiments, the logic of the unsupported RFSP index recovery service associated with the PCF may relate to a policy association procedure or another type of procedure that may include communicating an RFSP index value.

According to an exemplary embodiment, the PCF may generate and transmit a message, which includes an authorized RFSP index, to core device 122, such as the AMF. According to an exemplary embodiment, the PCF or the HSS may include an RFSP failure trigger, as described herein.

According to an exemplary embodiment, the PCF may provide an updated RFSP index failure responsive to a message indicating an RFSP index value is unsupported by access device 107. The PCF may provide an updated RFSP index value, in response to this message, to the AMF, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an IoT device, a drone, a smart device, a television, a set top box, a media player or streaming device, a telematics device, or another type of wireless device (e.g., another type of UE). End device 130 may be configured to execute various types of software (e.g., applications, programs, etc.) that enable access and use of various application services, as described herein. The number and the types of software may vary among end devices 130. End devices 130 may include “edge-aware” and/or “edge-unaware” application service clients. For purposes of description, end device 130 is not considered a network device.

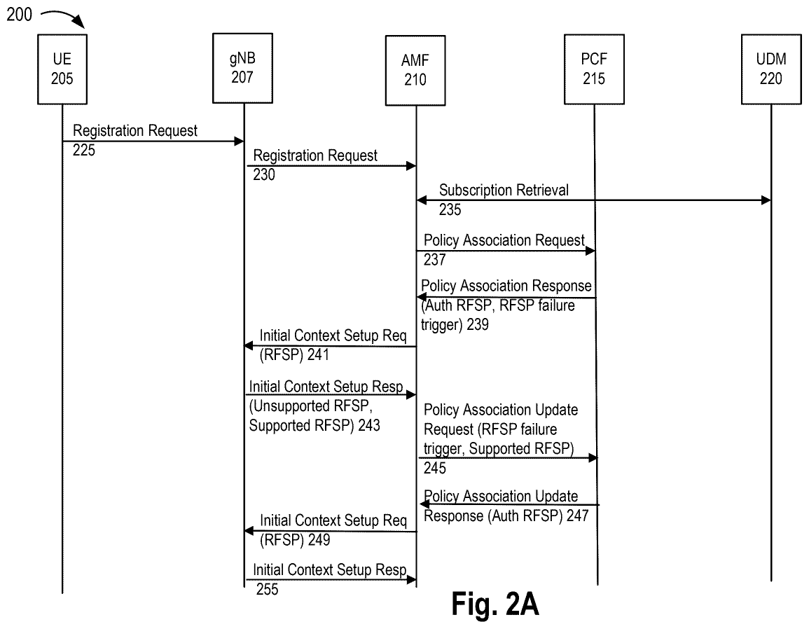

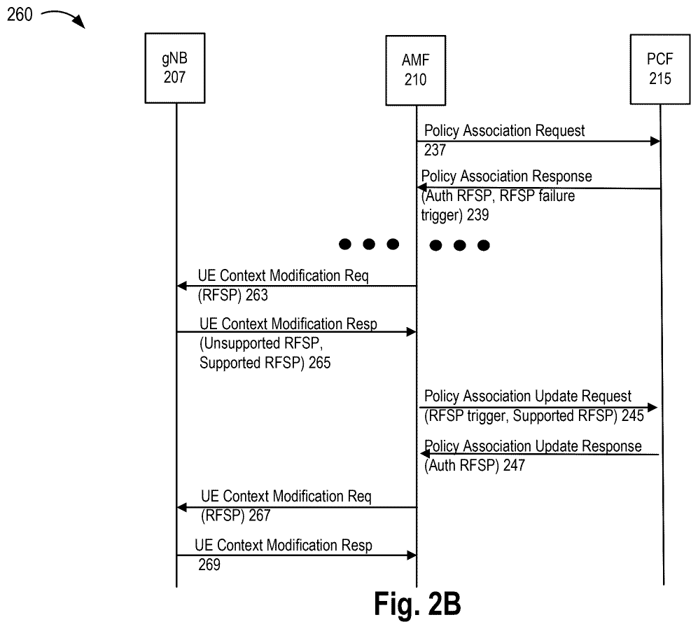

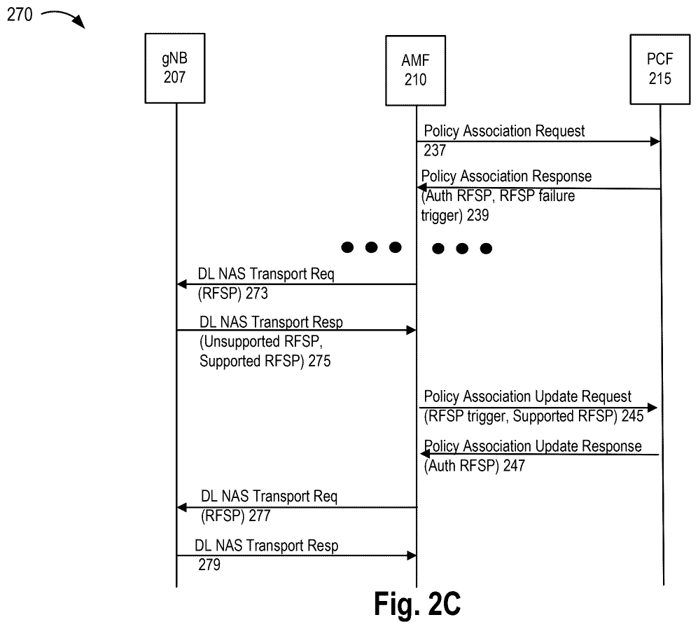

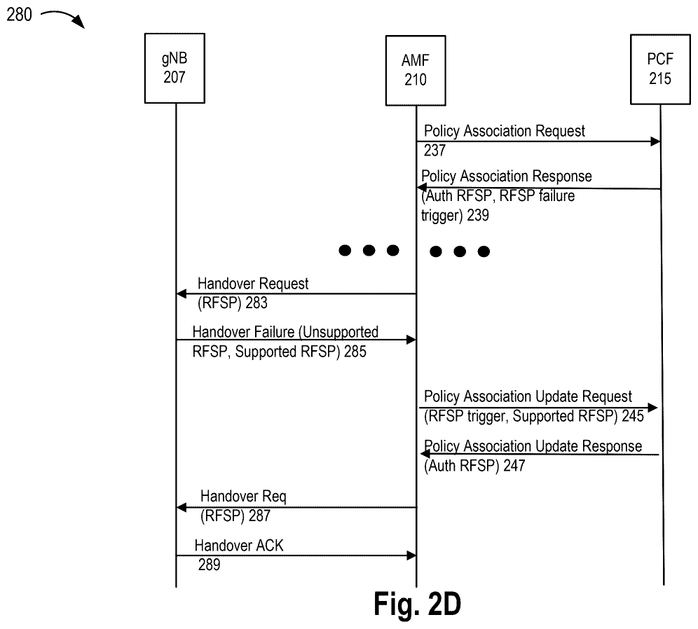

FIG. 2A is a diagram illustrating an exemplary process 200 of an exemplary embodiment of the unsupported RFSP index recovery service. As illustrated, process 200 may involve exemplary network devices, such as a gNB 207, an AMF 210, a PCF 215, and a UDM 220. gNB 207 is an exemplary implementation of access device 107. AMF 210, PCF 215, and UDM 220 are each exemplary implementations of core device 122. Process 200 may further involve a UE 205, which is an exemplary implementation of end device 130.

For purposes of brevity and avoidance of obscuring aspects of the unsupported RFSP index recovery service, some messages pertaining to initial registration have been omitted. Accordingly, in practice, additional messages may be exchanged and additional core devices 122 may be involved in the initial registration procedure. The messages illustrated in FIG. 2A and described are exemplary. Additionally, the network devices illustrated and described are exemplary.

Process 200 may pertain to a registration context, which includes an initial context setup procedure, as described herein. However, according to other exemplary embodiments of the unsupported RFSP index recovery service, modifications to process 200 may be implemented to accommodate other contexts and procedures, as described herein.

UE 205, AMF 210, PCF 215, and UDM 220 may each include logic that performs an operation or provides a function that is in accordance with a technical specification associated with a network standardizing body, such as 3GPP, 3GPP 2, ITU, ETSI, GSMA, or the like. According to some exemplary embodiments, UE 205, AMF 210, PCF 215, and UDM 220, or a sub-combination thereof, may be configured with logic that provides a proprietary operation or function not specified by the network standard. According to an exemplary embodiment, gNB 207, AMF 210, and PCF 215 may each include logic of the unsupported RFSP index recovery service, as described herein.

Referring to FIG. 2A, as a part of a Radio Resource Control (RRC) connection setup procedure, UE 202 may generate and transmit a non-access stratum (NAS) message, such as a registration request 225, to gNB 207. Although not illustrated, gNB 207 may select an AMF, such as AMF 210, and generate and transmit a message that includes a registration request 230 to AMF 210. Thereafter, AMF 210 may register with UDM 220 and perform a subscription retrieval procedure 235. For example, AMF 210 may obtain access and mobility (AM) subscription data and SMF selection subscription data, and create a UE context.

As further illustrated, AMF 210 may select a PCF, such PCF 215, and may perform a policy association procedure with PCF 215. For example, AMF 210 may generate and transmit an AM policy association establishment request 237 to PCF 215. Request 237 may include an identifier of UE 205 (e.g., subscription permanent identifier (SUPI), generic public subscription identifier (GPSI), or the like), access type, RAT type, allowed NSSAI, an RFSP index (e.g., a subscribed RFSP index), and other types of information that may be in accordance with a network standard. In response, PCF 215 may generate and transmit a policy association establishment response 239 to AMF 210. For example, response 239 may include access and mobility control policies, which may include an authorized RFSP index, among other potential information (e.g., service area restrictions, other types of policy control request triggers, etc.). According to an exemplary embodiment, response 239 may further include an RFSP index failure trigger. As previously described, the RFSP index failure trigger may include data indicating that if an RFSP index failure event occurs, for AMF 210 to notify PCF 215 of such event.

Although not illustrated, after setup of a UPF, AMF 210 may perform an initial context setup procedure. For example, AMF 210 may generate and transmit an initial context setup request 241 to gNB 207. Request 241 may include various instances of initial UE context information, such as a packet data unit (PDU) session context, security key, mobility restriction list, UE radio capability, and an RFSP index. In response, gNB 207 may store the UE context information. According to an exemplary embodiment, gNB 207 may compare the authorized RFSP index to one or multiple RFSP indexes that may be supported by gNB 207. According to this exemplary scenario, in response to the comparison, gNB 207 may determine that the authorized RFSP index is not supported by gNB 207.

According to an exemplary embodiment, gNB 207 may generate and transmit an initial context setup response 243 to AMF 210. According to some exemplary embodiments, response 243 may be implemented as an initial context setup failure message. According to an exemplary embodiment, response 243 may include data indicating that the authorized RFSP index is not supported by gNB 207. According to an exemplary embodiment, response 243 may include one or multiple RFSP indexes that are supported by gNB 207.

In response to receiving and reading response 243, and identifying the RFSP failure trigger data received in response 239 from PCF 215, AMF 210 may generate and transmit a policy association update request 245 to PCF 215. According to some exemplary embodiments, request 245 may be implemented as an AM policy association modification request. According to an exemplary embodiment, request 245 may include data indicating the occurrence of the RFSP index failure event. According to an exemplary embodiment, request 245 may further include one or multiple RFSP indexes supported by gNB 207.

In response to receiving and reading request 245, PCF 215 may include selecting an updated or (new) authorized RFSP index. According to some exemplary embodiments, when request 245 includes the one or multiple RFSP indexes supported by gNB 207, PCF 215 may select the updated RFSP index based on such information. For example, PCF 215 may select a supported RFSP index. According to an exemplary embodiment, PCF 215 may select the updated RFSP index, which differs from the authorized RFSP index provided in response 239, based on other criteria, such as subscribed RFSP indexes associated with UE 205, access and mobility control policies, and so forth.

PCF 215 may generate and transmit a policy association update response 247 to AMF 210. According to some exemplary embodiments, response 247 may be implemented as an AM policy association modification response. According to an exemplary embodiment, response 247 may include the updated RFSP index.

In response to receiving and reading response 247, AMF 210 may re-perform the initial context setup procedure. For example, AMF 210 may generate and transmit an initial context setup request 249 to gNB 207. Request 249 may include various instances of initial UE context information, such as a packet data unit (PDU) session context, security key, mobility restriction list, UE radio capability, and the updated RFSP index. In response, gNB 207 may store the UE context information. According to an exemplary embodiment, gNB 207 may compare the updated RFSP index to one or multiple RFSP indexes that may be supported by gNB 207. According to this exemplary scenario, in response to the comparison, gNB 207 may determine that the updated RFSP index is supported by gNB 207. gNB 207 may generate and transmit an initial context setup response 255 to AMF 210.

FIG. 2A illustrates an exemplary process 200, however, according to other exemplary embodiments and scenarios, process 200 may include additional operations or fewer operations, and different operations, or a sub-combination thereof, and/or additional messages or fewer messages, and different messages, or a sub-combination thereof, depending on the context.

FIG. 2B is a diagram illustrating another exemplary process 260 of an exemplary embodiment of the unsupported RFSP index recovery service. According to an exemplary embodiment, the process relates to a UE context modification procedure. For example, the UE context modification procedure may be performed to modify an established UE context. For the sake of brevity, messages 237, 239, 245, and 247 may be implemented in a manner similar to that previously described in relation to FIG. 2A or process 200.

For purposes of brevity and avoidance of obscuring aspects of the unsupported RFSP index recovery service, some messages pertaining the UE context modification procedure have been omitted. For example, some message subsequent to message 239 and before message 263 may occur, which are illustrated by way of ellipses. Accordingly, in practice, additional messages may be exchanged and additional core devices 122 may be involved in UE context modification procedure. The messages illustrated in FIG. 2B and described are exemplary. Additionally, the network devices illustrated and described are exemplary.

Referring to FIG. 2B, according to an exemplary scenario, AMF 210 may generate and transmit a UE context modification request 263 to gNB 207. As illustrated, request 263 may include an RFSP index. In response to receiving and reading request 263, gNB 207 may compare the authorized RFSP index to one or multiple RFSP indexes that may be supported by gNB 207. According to this exemplary scenario, in response to the comparison, gNB 207 may determine that the authorized RFSP index is not supported by gNB 207.

According to an exemplary embodiment, gNB 207 may generate and transmit a UE context modification response 265 to AMF 210. According to some exemplary embodiments, response 265 may be implemented as a UE context modification failure message. According to an exemplary embodiment, response 265 may include data indicating that the authorized RFSP index is not supported by gNB 207. According to some exemplary embodiments, the data may be implemented in Cause information element (IE). According to an exemplary embodiment, response 265 may include one or multiple RFSP indexes that are supported by gNB 207.

As further illustrated and previously described, messages 245 and 247 may be communicated. In response to receiving and reading response 247, AMF 210 may re-perform the UE context modification procedure. For example, AMF 210 may generate and transmit a UE context modification request 267 to gNB 207. Request 267 may include the updated RFSP index. In response, gNB 207 may store the UE context information. According to an exemplary embodiment, gNB 207 may compare the updated RFSP index to one or multiple RFSP indexes that may be supported by gNB 207. According to this exemplary scenario, in response to the comparison, gNB 207 may determine that the updated RFSP index is supported by gNB 207. gNB 207 may generate and transmit a UE context modification response 269 to AMF 210.

FIG. 2B illustrates an exemplary process 260, however, according to other exemplary embodiments and scenarios, process 260 may include additional operations or fewer operations, and different operations, or a sub-combination thereof, and/or additional messages or fewer messages, and different messages, or a sub-combination thereof, depending on the context.

FIG. 2C is a diagram illustrating yet another exemplary process of an exemplary embodiment of the unsupported RFSP index recovery service. According to an exemplary embodiment, the process relates to a DL NAS transport procedure. For example, AMF 210 may need to send a NAS message transparently via gNB 207 to UE 205. For the sake of brevity, messages 237, 239, 245, and 247 may be implemented in a manner similar to that previously described in relation to FIG. 2A or process 200.

For purposes of brevity and avoidance of obscuring aspects of the unsupported RFSP index recovery service, some messages pertaining to the DL NAS transport procedure have been omitted. For example, some message subsequent to message 239 and before message 273 may occur, which are illustrated by way of ellipses. Accordingly, in practice, additional messages may be exchanged and additional core devices 122 may be involved in the DL NAS transport procedure. The messages illustrated in FIG. 2C and described are exemplary. Additionally, the network devices illustrated and described are exemplary.

Referring to FIG. 2C, according to an exemplary scenario, AMF 210 may generate and transmit a DL NAS transport request 273 to gNB 207. As illustrated, request 273 may include an RFSP index. In response to receiving and reading request 273, gNB 207 may compare the authorized RFSP index to one or multiple RFSP indexes that may be supported by gNB 207. According to this exemplary scenario, in response to the comparison, gNB 207 may determine that the authorized RFSP index is not supported by gNB 207.

According to an exemplary embodiment, gNB 207 may generate and transmit a DL NAS transport response 275 to AMF 210. According to some exemplary embodiments, response 275 may be implemented as a NAS non-delivery indication message. According to an exemplary embodiment, response 275 may include data indicating that the authorized RFSP index is not supported by gNB 207. According to an exemplary embodiment, response 265 may include one or multiple RFSP indexes that are supported by gNB 207.

As further illustrated and previously described, messages 245 and 247 may be communicated. In response to receiving and reading response 247, AMF 210 may re-perform the DL NAS transport procedure. For example, AMF 210 may generate and transmit a DL NAS transport request 277 to gNB 207. Request 277 may include the updated RFSP index. According to an exemplary embodiment, gNB 207 may compare the updated RFSP index to one or multiple RFSP indexes that may be supported by gNB 207. According to this exemplary scenario, in response to the comparison, gNB 207 may determine that the updated RFSP index is supported by gNB 207. gNB 207 may generate and transmit a DL NAS transport response 279 to AMF 210.

FIG. 2C illustrates an exemplary process 270, however, according to other exemplary embodiments and scenarios, process 270 may include additional operations or fewer operations, and different operations, or a sub-combination thereof, and/or additional messages or fewer messages, and different messages, or a sub-combination thereof, depending on the context.

FIG. 2D is a diagram illustrating still another exemplary process of an exemplary embodiment of the unsupported RFSP index recovery service. According to an exemplary embodiment, the process relates to a handover procedure. For the sake of brevity, messages 237, 239, 245, and 247 may be implemented in a manner similar to that previously described in relation to FIG. 2A or process 200.

For purposes of brevity and avoidance of obscuring aspects of the unsupported RFSP index recovery service, some messages pertaining to the handover procedure have been omitted. For example, some message subsequent to message 239 and before message 283 may occur, which are illustrated by way of ellipses. Accordingly, in practice, additional messages may be exchanged and additional core devices 122 may be involved in the handover procedure. The messages illustrated in FIG. 2D and described are exemplary. Additionally, the network devices illustrated and described are exemplary.

Referring to FIG. 2D, according to an exemplary scenario, AMF 210 may generate and transmit a handover request 283 to gNB 207. According to this example, gNB 207 may be the target RAN node. As illustrated, request 283 may include an RFSP index. In response to receiving and reading request 283, gNB 207 may compare the authorized RFSP index to one or multiple RFSP indexes that may be supported by gNB 207. According to this exemplary scenario, in response to the comparison, gNB 207 may determine that the authorized RFSP index is not supported by gNB 207.

According to an exemplary embodiment, gNB 207 may generate and transmit a handover failure message 285 to AMF 210. According to an exemplary embodiment, failure message 285 may include data indicating that the authorized RFSP index is not supported by gNB 207. According to an exemplary embodiment, failure message 285 may include one or multiple RFSP indexes that are supported by gNB 207.

As further illustrated and previously described, messages 245 and 247 may be communicated. In response to receiving and reading response 247, AMF 210 may re-perform the handover procedure. For example, AMF 210 may generate and transmit a handover request 287 to gNB 207. Request 287 may include the updated RFSP index. According to an exemplary embodiment, gNB 207 may compare the updated RFSP index to one or multiple RFSP indexes that may be supported by gNB 207. According to this exemplary scenario, in response to the comparison, gNB 207 may determine that the updated RFSP index is supported by gNB 207. gNB 207 may generate and transmit a handover acknowledgement 289 to AMF 210.

FIG. 2D illustrates an exemplary process 280, however, according to other exemplary embodiments and scenarios, process 280 may include additional operations or fewer operations, and different operations, or a sub-combination thereof, and/or additional messages or fewer messages, and different messages, or a sub-combination thereof, depending on the context.

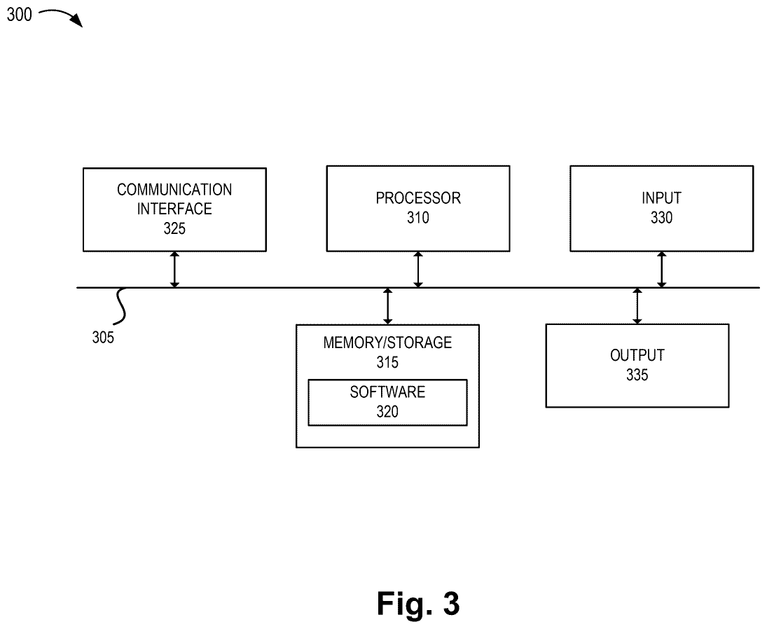

FIG. 3 is a diagram illustrating exemplary components of a device that may correspond to one or more of the devices illustrated and described herein. For example, device 300 may correspond to access device 107, external device 117, core device 122, end device 130, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques and/or technologies including, for example, multithreading, parallel processing, pipelining, interleaving, machine learning, artificial intelligence, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, a solid state drive, mass storage, off-line storage, cloud storage, or some other type of storing medium. Memory/storage 315 may store data, software, and/or instructions related to the operation of device 300.

Software 320 includes an application or a program that provides a function and/or a process. As an example, with reference to access device 107, software 320 may include an application that, when executed by processor 310, provides a function and/or a process of unsupported RFSP index recovery service, as described herein. Software 320 may also include firmware, middleware, microcode, hardware description language (HDL), and/or other form of instruction. Software 320 may also be virtualized. Software 320 may further include an operating system.

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, spun-up, uninstantiated, deleted, spun-down, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions that are stored by memory/storage 315 may configure and cause processor 310 to perform a function or a process described herein. Alternatively, for example, according to other implementations, device 300 performs a function or a process described herein based on the execution of hardware (processor 310, etc.).

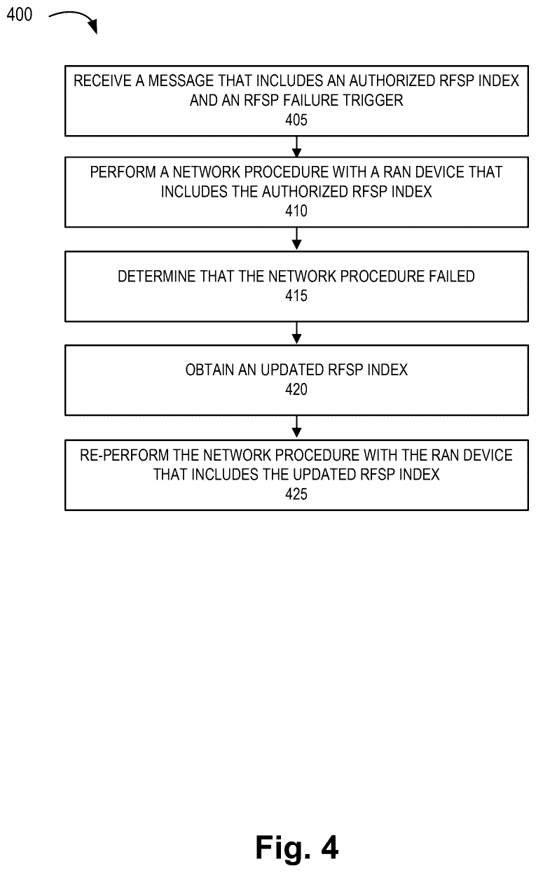

FIG. 4 is a flow diagram illustrating an exemplary process 400 of an exemplary embodiment of the unsupported RFSP index recovery service. According to an exemplary embodiment, an AMF (e.g., AMF 210) or the like, as described herein, may perform a step of process 400. According to an exemplary implementation, processor 310 executes software 320 to perform a step of process 400, as described herein. Alternatively, a step may be performed by execution of only hardware.

In block 405, the AMF may receive a message that includes authorized RFSP index and an RFSP failure trigger. For example, the AMF may receive the message from a PCF in relation to an AM policy association procedure, as described herein.

In block 410, the AMF may perform a network procedure with a RAN device that includes the authorized RFSP index. For example, the AMF may perform an initial context setup procedure, a UE context modification procedure, a DL NAS transport procedure, a handover procedure, or some other type of procedure that may include communication of an RFSP index with access device 107.

In block 415, the AMF may determine that the network procedure failed. For example, the AMF may receive a failure message from access device 107, as described herein.

In block 420, the AMF may obtain an updated RFSP index. For example, based on the received failure message and the RFSP failure trigger, the AMF may obtain an updated RFSP index from the PCF, as described herein. The AMF may provide the PCF with a supported RFSP index communicated by access device 107.

In block 425, the AMF may re-perform the network procedure with the RAN device that includes the updated RFSP index. For example, the AMF may re-perform the initial context setup procedure, the UE context modification procedure, the DL NAS transport procedure, the handover procedure, or some other type of procedure that may include communication of an RFSP index with access device 107. The AMF may provide access device 107 with the updated RFSP index. According to an exemplary embodiment, the network procedure may successfully be completed.

FIG. 4 illustrates an exemplary process 400 of the unsupported RFSP index recovery service, according to other exemplary embodiments, the unsupported RFSP index recovery service may perform additional operations, fewer operations, and/or different operations than those illustrated and described.

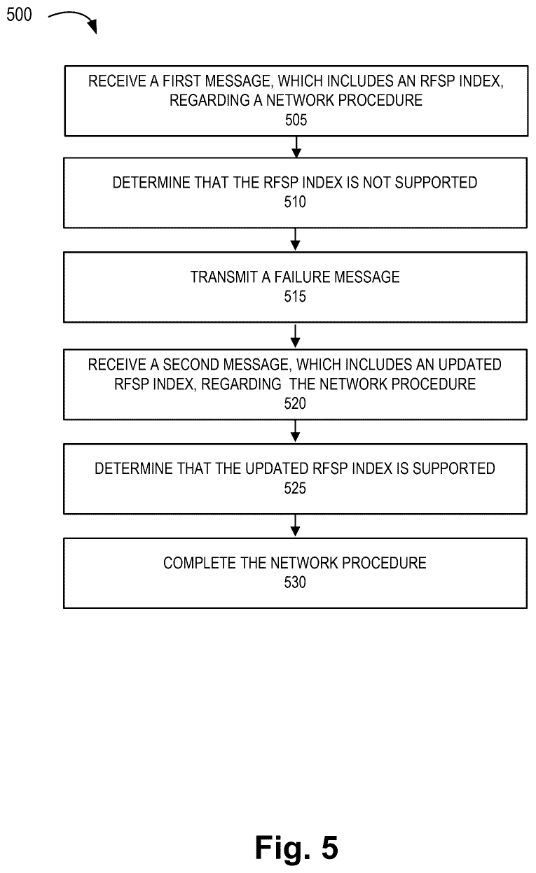

FIG. 5 is a flow diagram illustrating an exemplary process 500 of an exemplary embodiment of the unsupported RFSP index recovery service. According to an exemplary embodiment, access device 107 (e.g., gNB 207) or the like, as described herein, may perform a step of process 500. According to an exemplary implementation, processor 310 executes software 320 to perform a step of process 500, as described herein. Alternatively, a step may be performed by execution of only hardware.

In block 505, the access device may receive a first message, which includes an RFSP index, regarding a network procedure. For example, access device 107 may receive the first message from an AMF (e.g., AMF 210), as described herein. The network procedure may pertain to an initial context setup procedure, a UE context modification procedure, a DL NAS transport procedure, a handover procedure, or some other type of procedure that may include communication of the RFSP index, as described herein.

In block 510, the access device may determine that the RFSP index is not supported. For example, access device 107 may compare the RFSP index to supported RFSP index(es) associated with access device 107.

In block 515, the access device may transmit a failure message. For example, access device 107 may transmit the appropriate failure message in relation to the given network procedure, as described herein. The failure message may indicate that the RFSP index is not supported. The failure message may include one or multiple supported RFSP indexes, as described herein.

In block 520, the access device may receive a second message, which includes an updated RFSP index, regarding the network procedure, as described herein.

In block 525, the access device may determine that the updated RFSP index is supported, as described herein. In block 530, the access device may complete the network procedure, as described herein.

FIG. 5 illustrates an exemplary process 500 of the unsupported RFSP index recovery service, according to other exemplary embodiments, the unsupported RFSP index recovery service may perform additional operations, fewer operations, and/or different operations than those illustrated and described.

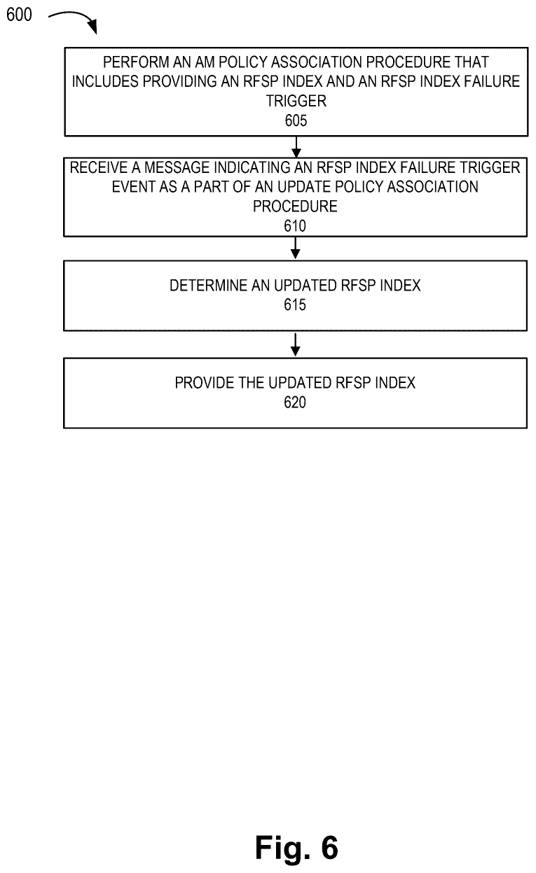

FIG. 6 is a flow diagram illustrating an exemplary process 600 of an exemplary embodiment of the unsupported RFSP index recovery service. According to an exemplary embodiment, a PCF (e.g., PCF 215) or the like, as described herein, may perform a step of process 600. According to an exemplary implementation, processor 310 executes software 320 to perform a step of process 600, as described herein. Alternatively, a step may be performed by execution of only hardware.

In block 605, the PCF may perform an AM policy association procedure that includes providing an RFSP index and an RFSP index failure trigger, as described herein. For example, PCF 215 may perform the procedure with AMF 210, as described herein.

In block 610, the PCF may receive a message indicating an RFSP index trigger event. For example, as a part of an update policy association procedure, AMF 210 may provide the occurrence of the RFSP index failure event and request an updated RFSP index. The message may include a supported RFSP index relating to access device 107, as described herein.

In block 615, the PCF may determine an updated RFSP index, as described herein.

In block 620, the PCF may provide the updated RFSP index. For example, PCF 215 may provide the updated RFSP index to AMF 210.

FIG. 6 illustrates an exemplary process 600 of the unsupported RFSP index recovery service, according to other exemplary embodiments, the unsupported RFSP index recovery service may perform additional operations, fewer operations, and/or different operations than those illustrated and described.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” The term “substantially” is used herein to represent a degree by which a quantitative representation may vary from a stated reference without resulting in a change in the basic function of the subject matter at issue.

Any embodiment or implementation described as “exemplary” is not necessarily to be construed as preferred or advantageous over other embodiments or implementations.

In addition, while a series of blocks has been described regarding the process illustrated in FIG. 5, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
obtaining, by a network device, a first Radio Access Technology Frequency Selection Priority (RFSP) index and an RFSP failure trigger;
performing, by the network device, a network procedure, which includes the first RFSP index, with a radio access network (RAN) device;
determining, by the network device, that the network procedure failed;
obtaining, by the network device in response to the determining, a second RFSP index; and
reperforming, by the network device, the network procedure, which includes the second RFSP index, with the RAN device.

2. The method of claim 1, wherein the first RFSP index and the RFSP failure trigger is obtained from a policy control function (PCF) as a part of a policy association procedure with the PCF.

3. The method of claim 1, wherein the performing further comprises:
receiving, by the network device from the RAN device, a failure message that includes a supported RFSP index of the RAN device.

4. The method of claim 3, wherein the obtaining of the second RFSP index further comprises:
transmitting, by the network device, a message that includes the supported RFSP index of the RAN device.

5. The method of claim 1, wherein the network procedure fails because the first RFSP index is not supported by the RAN device.

6. The method of claim 1, wherein the network procedure pertains to a downlink non-access stratum transport procedure or a handover procedure.

7. The method of claim 1, wherein the network procedure pertains to an initial context setup procedure or a user equipment (UE) context modification procedure.

8. The method of claim 1, wherein the network device is an access and mobility management function (AMF).

9. A network device comprising:
a processor that is configured to:
obtain a first Radio Access Technology Frequency Selection Priority (RFSP) index and an RFSP failure trigger;
perform a network procedure, which includes the first RFSP index, with a radio access network (RAN) device;
determine that the network procedure failed;
obtain, in response to the determining, a second RFSP index; and
reperform the network procedure, which includes the second RFSP index, with the RAN device.

10. The network device of claim 9, wherein the first RFSP index and the RFSP failure trigger is obtained from a policy control function (PCF) as a part of a policy association procedure with the PCF.

11. The network device of claim 9, wherein, when performing, the processor is further configured to:
receive, from the RAN device, a failure message that includes a supported RFSP index of the RAN device.

12. The network device of claim 11, wherein, when obtaining the second RFSP index, the processor is further configured to:
transmit a message that includes the supported RFSP index of the RAN device.

13. The network device of claim 9, wherein the network procedure fails because the first RFSP index is not supported by the RAN device.

14. The network device of claim 9, wherein the network procedure pertains to a downlink non-access stratum transport procedure or a handover procedure.

15. The network device of claim 9, wherein the network procedure pertains to an initial context setup procedure or a user equipment (UE) context modification procedure.

16. The network device of claim 9, wherein the network device is an access and mobility management function (AMF).

17. A non-transitory computer-readable storage medium storing instructions executable by a processor of a network device, wherein the instructions are configured to:
obtain a first Radio Access Technology Frequency Selection Priority (RFSP) index and an RFSP failure trigger;
perform a network procedure, which includes the first RFSP index, with a radio access network (RAN) device;
determine that the network procedure failed;
obtain, in response to the determining, a second RFSP index; and
reperform the network procedure, which includes the second RFSP index, with the RAN device.

18. The non-transitory computer-readable storage medium of claim 17, wherein the network procedure fails because the first RFSP index is not supported by the RAN device.

19. The non-transitory computer-readable storage medium of claim 17, wherein the network procedure pertains to an initial context setup procedure or a user equipment (UE) context modification procedure.

20. The non-transitory computer-readable storage medium of claim 17, wherein the network procedure pertains to a downlink non-access stratum transport procedure or a handover procedure.
